(19) United States
(12) Patent Application Publication
(10) Pub. No.: US 2013/0003596 A1
(43) Pub. Date: Jan. 3, 2013

(54) METHOD AND DEVICE FOR RELOCATING ADDRESS SPACE

(75) Inventors: Armand Michel Marie Lelkens, Heerlen (NL); Andreas Achtzehn, Bornheim (DE); Xiangyu Wang, Eindhoven (NL)

(73) Assignee: KONINKLIJKE PHILIPS ELECTRONICS, N.V., EINDHOVEN (NL)

(21) Appl. No.: 13/634,323

(22) PCT Filed: Mar. 11, 2011
(86) PCT No.: PCT/IB2011/051026

§ 371 Date: Sep. 12, 2012

(30) Foreign Application Priority Data
Mar. 19, 2010 (EP) 10156989.5

(51) Int. Cl. H04L 12/28; H04L 12/26

(52) U.S. Cl. 370/252; 370/254

(57) ABSTRACT

The invention relates to a method for relocating address space in a peer-to-peer network with hierarchical addressing is performed in a network (1) that has a tree structure with routers (3) at different network depths (D). Each router (3) has an assigned address space (10), including an identifying address (11) for the router (3), one or more address blocks (12) for providing further routers (3) with assigned address space (10) and a further address block (13) for providing end devices with identifying addresses. The size of the address space (10) assigned to a router (3) without relocation depends on the network depth (D) of the router (3) in a predetermined way, leading to specific sizes of the address space (10) assigned to routers (3). The method comprises the following steps: An association request is received from a joining router or a joining end device by a first router (3) of the network (1), wherein the address space (10) of the first router (3) is exhausted. The first router (3) sends a relocation request (20) to a second router (3) of the network (1), wherein the relocation request denotes a size of a requested address block (12), and wherein the size of the requested address block (12) equals one of the specific address space sizes. The invention further relates to a router (3) for use in an according network (1), the router (3) being suited to perform the described method.

### FIELD OF THE INVENTION

The invention relates to a method for relocating address space in a peer-to-peer network with hierarchical addressing. The invention further relates to a router for use in a peer-to-peer network suited to perform said method.

### BACKGROUND OF THE INVENTION

Peer-to peer networks, and in particular wireless peer-to-peer networks, become increasingly important for applications such as building automation, lighting control, monitoring application and medical applications.

Peer-to-peer networks usually employ an addressing scheme that makes a flexible organization and re-organization of the network possible, including the option of new devices joining the network at any time and at a variety of access points (ad-hoc network). An example of a flexible peer-to-peer network is provided by the ZigBee standard, specified by the ZigBee alliance.

The ZigBee standard proposes a hierarchical scheme, where addresses are assigned in a distributed fashion. ZigBee is an open standard based on the IEEE 802.15.4 communications protocol that defines a physical link layer (PHY) and a media access control layer (MAC). In addition to these protocol layers, ZigBee defines a network layer and an application layer on top of the PHY- and MAC-layer.

A ZigBee network usually comprises two different kind of devices. A first kind of device is called a router. A router is capable of connecting other devices to the network and of routing packets through the network. Despite this routing function, it usually also provides an application functionality, e.g. reading a sensor or controlling an appliance. The other kind of devices are called end devices. They are not capable of connecting other devices, and only provide their application functionality to the user of the network.

In hierarchical addressing, a router is assigned a block of consecutive addresses, called its address space. The first address of the address space is usually used to identify the router itself. The remaining addresses are divided in the following way. One part of the addresses is kept by the router for connecting end devices, each of which is assigned a single address of this part of the address space. The remaining addresses of the address space are evenly split into a predetermined number of address blocks. If another router joins the network, one of the address blocks is assigned to the new, joining router as its address space. This router again uses one of the addresses of the address space as its own address and splits the remainer of the address space in the same manner. The router that assigns an address block is also referred to as the parent router to the router that receives the address block, which in turn is called the child of the parent router. The distributed assignment of address space leads to a tree-like hierarchical addressing scheme. The distance (in terms of parent-child generations) of a router (or node of the tree) from the root node of the tree is called the network depth or network level of the router.

The first router in the system, located at the root node of the tree structure, is equipped with an address space of a predetermined size, for example containing 2¹⁶ addresses in case of a ZigBee network. As a result of the hierarchical addressing procedure, the size of the address space assigned to further routers joining the network decreases with increasing network depth. At some point, the address space assigned to a router is too small to be further divided. Thus, the maximum network depth is limited for a network with hierarchical addressing and depends on the total size of the address space and the parameters of the dividing procedure.

A disadvantage of hierarchical addressing with the described standard static division procedure is the resulting inflexible topology of the network tree. Routers may for example run out of free address blocks for connecting further children. This occurs if the number of address blocks per address space in the division procedure, which defines the maximum number of children that a parent router can have, is chosen too small (deep but narrow tree). However, the value for the maximum number of children cannot be arbitrarily increased, because this value also influences the maximum depth of the network. With the number of router children chosen too high, the network depth is exhausted too fast (shallow but wide tree). Given the limited address space width of for example sixteen bit according to the ZigBee specification, a compromise between the maximum number of router children per router and the maximum network depth has to be made.

In order to overcome the limitations imposed by the standard address allocation procedure, address space relocation mechanisms have been proposed. Document US 2008/0159289 A1 for example discloses that a router which receives a request for joining the network from a further router can issue a relocation request to its parent and further ancestors in direction of the root node in the hierarchical address tree to ask whether one of these routers has free addresses available. The free addresses are then assigned to the new router via the router that received the joining request. That way, the address space is logically rearranged or relocated, which gives the possibility for a router to have more children than was originally predetermined according to the division procedure. A disadvantage of the described relocation procedure is that it can result in a fragmented address space.

It would therefore be advantageous to achieve a method for relocating address space that prevents a fragmentation of the address space.

### SUMMARY OF THE INVENTION

The present application contemplates a method for relocating address space in a peer-to-peer network with hierarchical addressing, wherein the network has a tree structure with routing devices at different network depths, each router having an assigned address space, including an identifying address for the router, one or more address blocks for providing further routers with assigned address space and a further address block for providing end devices with identifying addresses. The size of the address space assigned to a router without relocation depends on the network depth of the router in a predetermined way, leading to specific sizes of the address space assigned to routers.

The method comprises the following steps: A join request is received from a joining router or a joining end device by a first router of the network, the address space of which is exhausted. The first router sends a relocation request to a second router of the network, wherein the relocation request denotes a size of a requested address block and wherein the size of the requested address block equals one of the specific address space sizes.

Due to the standard procedure of dividing the address space of a router into smaller address blocks that are then assigned to the children of the router, the address space assigned to a router only takes specific sizes that depend on the parameters of the dividing procedure. The possible sizes are also called natural sizes in the following. According to the present application, a relocation request issued by a router that received a joining request but does not have any free address(es) available, address space is requested in one of the natural sizes resulting from the dividing procedure. That way, the relocated address blocks naturally fit into the standard address dividing scheme, thus avoiding the creation of unusable address blocks and accordingly avoiding fragmentation of the address space. Unusable address blocks would for example be blocks of a size that is just too small to be an address block within the standard dividing scheme.

In a preferred embodiment of the method, the size of the requested address block is stated in terms of a target network depth. That way, a short and unambiguous specification for the size of the requested address blocks is provided that guarantees that address blocks are requested in the specific sizes.

In a preferred embodiment of the method, the relocation request includes a distance counter value. A received relocation request is forwarded to the parent of the receiving router with the distance counter value decreased by one, if it was determined that the distance counter value was not equal to zero when the relocation request was received. That way, a relocation request first travels a predetermined (logical) distance towards the root of the network tree, before it is processed further. Accordingly, a (logical) distance range, within which the relocation of network space can occur, can be determined.

The present application further contemplates a router for use in a respective network, the router being suited to perform the method as described above. The advantages correspond to the advantages of the method.

Further advantageous embodiments are provided in the respective dependent claims. Still further advantages and benefits of the present invention will become apparent from and elucidated with reference to the embodiments described hereinafter in connection with the drawings.

### BRIEF DESCRIPTION OF THE DRAWINGS

In the drawings:

FIG. 1 shows a first example of a network tree structure;

FIG. 2 shows a second example of a network tree structure;

FIG. 3 shows a third example of a network tree structure;

FIG. 4 shows a flow chart of a first part of a method for relocating address space;

FIG. 5 shows a schematic diagram of the address spaces of a router and a child router;

FIG. 6 shows a schematic representation of a relocation request;

FIG. 7 shows a flow chart of a second part of a method for relocating address space;

FIG. 8 shows a schematic representation of a reply on a relocation request; and

FIG. 9 shows a third part of a method for relocating address space.

### DETAILED DESCRIPTION OF EMBODIMENTS

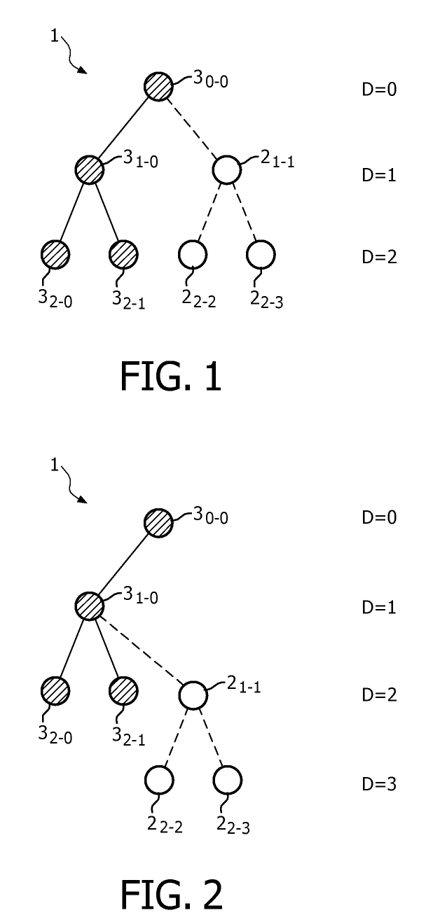

FIG. 1 shows a tree structure of the hierarchical addressing in a network 1. The network tree comprises empty nodes 2 (open symbols) and nodes occupied with routers 3 (shaded symbols). The reference signs of the empty nodes 2 and the routers 3 carry two indices that specify the position of the node 2 or router 3 within the network tree. The first index denotes a network depth D, which is also indicated on the right hand side of FIG. 1. The second index consecutively numbers the node (empty nodes 2 as well as routers 3 occupying a node) within each network depth D. The leaves of the tree could also be occupied by end devices.

Router 3₀₋₀ indicates the root of the network tree. This router 3₀₋₀ is assigned the total available address space. By way of example, it is assumed that one of the addresses of the address space is used for addressing the router 3₀₋₀ itself, some addresses are used for connecting end devices to the router 3₀₋₀, and the remaining address are evenly split into two address blocks, which can be assigned to further routers.

In the example shown, one of the two address blocks is assigned to a router 3₁₋₀ on the next network level D=1, while the other address block is not yet assigned to a router. In the figure, this is indicated by an empty node 2₁₋₁. Router 3₁₋₀ is called a child of router 3₀₋₀, which, in turn, is called the parent of router 3₁₋₀. The same terminology is used to characterize the relation of nodes among each other or between routers and nodes.

The address space assigned to router 3₁₋₀ is accordingly divided into two address blocks that can be assigned to routers located at the next network depth D=2. In the example of FIG. 1, both address blocks are assigned to child routers, namely to a router 3₁₋₂ and a router 3₁₋₀. The corresponding child nodes of empty node 2₁₋₁ are depicted as empty nodes 2₂₋₂ and 2₂₋₃.

It is noted that the shown tree structure represents the relationship of routers concerning the inheritance of addresses. Communication is possible along the shown connections between routers, but might also be possible between routers not directly connected in the shown tree structure. Known routing methods and methods for keeping, using and updating routing tables within each router can be applied.

FIG. 2 shows the hierarchical address tree of the network 1 of FIG. 1 after an address relocation. In the relocation process, the unused address block of router 3₀₋₀ has been transferred to router 3₁₋₀. As a result, router 3₁₋₀ can now assign address blocks to three child routers, namely router 3₂₋₀ and router 3₂₋₁ that were already assigned as children to router 3₁₋₀, and an additional address block for a new router taking the place of node 2₁₋₁. A router occupying this network node 2₁₋₁ would then be able to assign two address blocks to further routers, occupying nodes 2₂₋₂ and nodes 2₂₋₃.

Due to the relocation process, the overall address space obviously does not change, but the network is able to flexibly respond to a joining request that could otherwise not be fulfilled. The network system shown in FIG. 2 locally increases the number of children of a router (here three instead of two for router 3₁₋₀) and also locally extends the depth of the network (here with two possible routers on empty nodes 2₂₋₂ and 2₂₋₃ at a network depth of D=3). It is noted that a direct negotiation of address space between the joining router and router 3₀₋₀ instead of 3₁₋₀ might not have been possible due to the limited transmission range of the routers.

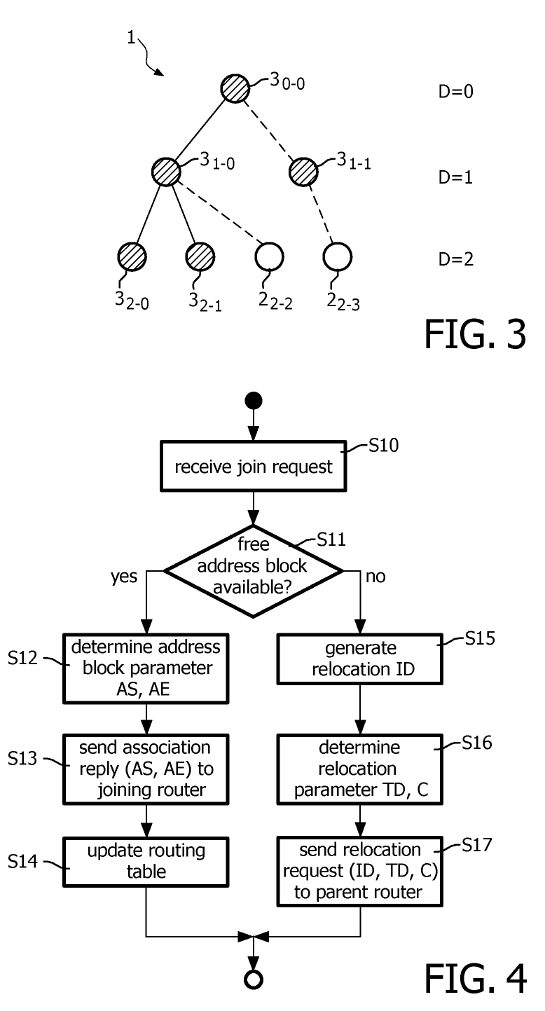

FIG. 3 shows another example of a possible relocation process. The starting point for the shown relocation was similar to the situation shown in FIG. 1, except for the difference that empty node 2₁₋₁ of FIG. 1 had already been occupied by a router 3₁₋₁. For the relocation shown in FIG. 3, one address block of the two unused address blocks of the address space of router 3₁₋₁ has been transferred to router 3₁₋₀. In this example, neither the maximum network depth of D=2 has changed, nor the number of possible routers at each network depth. However, locally, the number of possible routers assigned to a router has changed for router 3₁₋₀ (three instead of two possible child routers) and also for router 3₁₋₁ (one instead of two possible child routers).

Both shown relocation processes can be achieved by applying a method for relocating address space according to the application and described in connection with the following figures. By way of example and without any limitation, the method for relocating address space described in the following is explained with reference to the network 1 shown in FIG. 1. Since the method is applicable in distributed network systems, in which actions are not coordinated by a central coordinator, but rather performed by all devices present in the network system, each of the routers present in the network is capable of performing the described method.

FIG. 4 shows a flow chart of a first part of a method for relocating address space. In a first step S10, one of the routers already present in a network receives an association request, also called join request, of a router or an end device which is not yet part of the network. By way of example, it is assumed that the join request is issued by a router, which is denoted as the joining router in the following, even if at this stage it is not guaranteed that the association request will lead to the incorporation of this router into the network. By way of example, the joining request could have been received by router 3₁₋₀ of the network 1 shown in FIG. 1.

In a next step S11, the router that received the association request checks whether it has a free address block available that could be assigned to the joining router. If a free address block is available, the method continues with a step S12, in which parameters describing the address block are determined. These parameter could for example be the starting address AS of the address block and its last address, end address AE. Alternatively, the starting address AS and the size of the address block could be used as describing parameters.

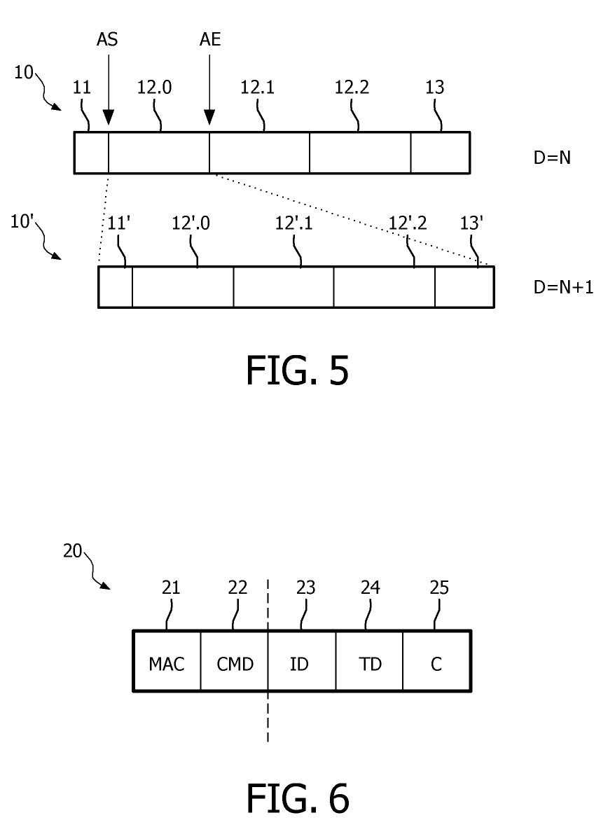

The determination of the address block parameters is explained in more detail in connection with FIG. 5. FIG. 5 shows a schematic representation of an address space 10 consisting of a plurality of consecutive addresses assigned to a router 3 positioned at a network depth D=N, where N stands for an arbitrarily chosen number. The address space 10 is divided in several parts, where a first part 11 contains the routers own identifying address, which is the unambiguous address used to address the router within the network. Usually, the router's own address 11 is located at the beginning of the address space 10. Located at the end of the address space 10, a block of addresses 13 is reserved for being assigned to end devices. The remaining addresses are evenly split into address blocks 12, here by way of example (and differing from the example shown in FIGS. 1 to 3) into three address blocks 12.0, 12.1 and 12.2. The size of the further address block 13 for the end devices and the number of the address blocks 12 is predetermined and kept the same within the entire network.

Back to FIG. 4, in a next step S13 an association reply containing the starting address AS and the end address AE as address block parameters is then sent to the joining router. In a next step S14, the router that received the association request updates its routing table with the starting address AS of the assigned address block, since this will be the identifying address of the joining router and will be used to route messages within a network to the joining router.

The address block assigned to the joining router will form the address space of the joining router. This is depicted in the lower part of FIG. 5, where the assigned address block 12.0 of the address space 10 of the router at network depth D=N forms the address space 10′ (shown enlarged) of the joining router at network depth D=N+1. This address space is in turn divided into the own identifying address 11′ of the joining router, three address blocks 12′.0 to 12′.2 for further routers, and a further address block 13′ reserved for end devices.

After step S14, the method finishes and the router would be ready to receive a further association request in step S10 by repeating the method.

If it was determined in step S11 that no free address block was available, or in other words, that the router that received the association request already had exhausted its address space, the method proceeds with a step S15. In step S15, an identifying number ID for a relocation request is generated. The generation process of the ID guarantees that that generated ID is unique within the system. One possibility to generate the ID would be to combine a number unique to the router, e.g. its own identifying address, with the time of generation or a sequence number (counter) local to the router. The generation process could also include the creation of a hash value.

In a next step S16, relocation parameters that control the relocation process are determined. The relocation parameters are a target (or desired) network depth TD and a distance counter C. The meaning of the two parameters TD and C will be described in the following in more detail. Predetermined and fixed values can be used for the parameters TD and C. In another embodiment, the values for the target network depth TD and the distance counter C can depend on the success of a preceding relocation request.

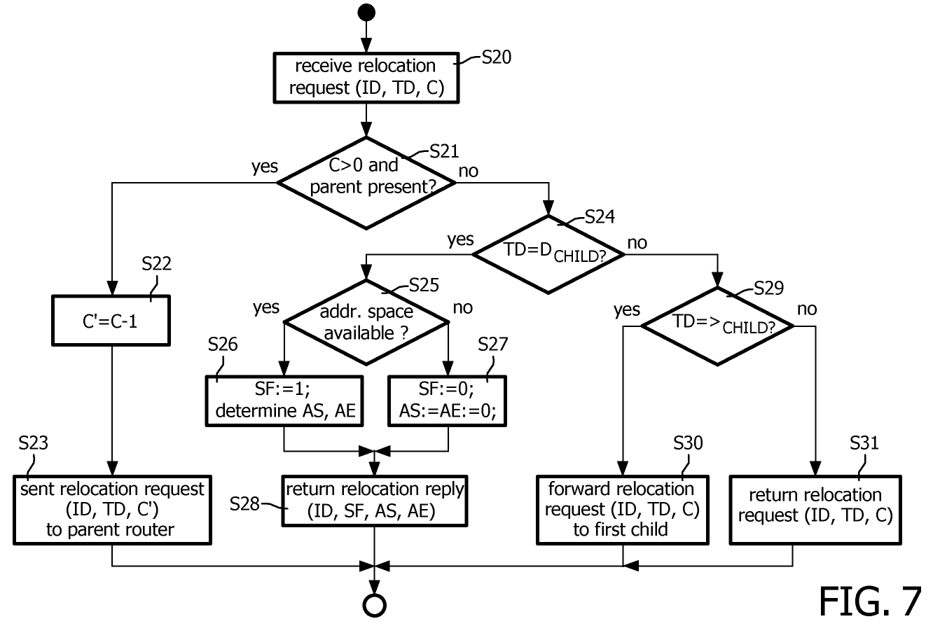

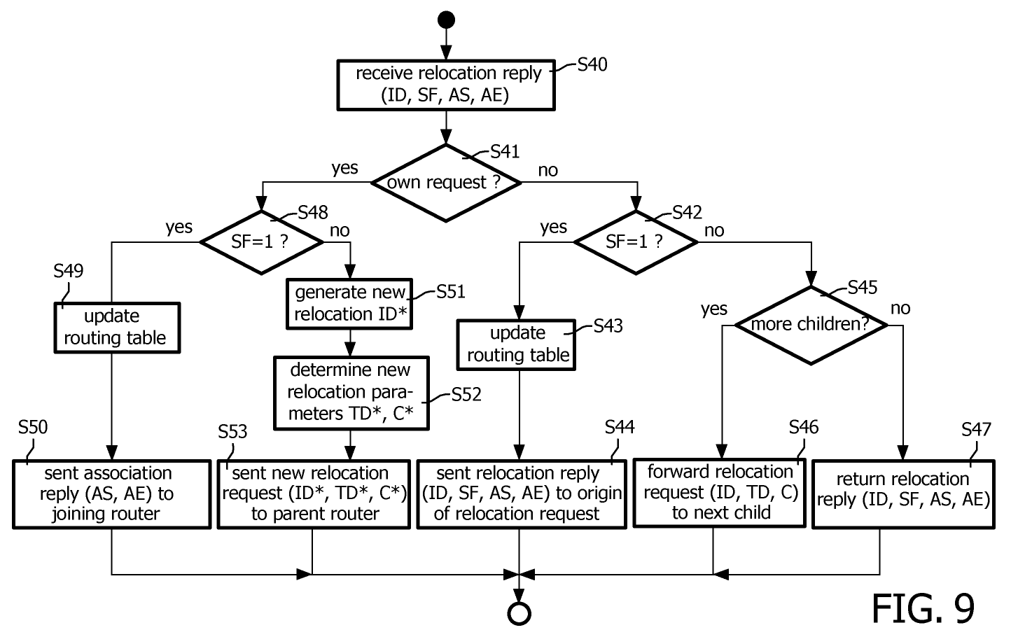

In a next step S17, a relocation request containing the ID, the target network depth TD and the distance counter C is sent to the parent of the router that received the association request. The method terminates after step S17, the router now being ready for receiving a further association request in step S10 in a repetition of the method, or being ready to receive a reply to the relocation request as described in connection with FIG. 9, or being ready to receive a relocation request, either the one sent out on return, or a different one, as described in connection with FIG. 7.

The structure of a sent relocation request 20 is shown in FIG. 6 in a schematic drawing. The relocation request 20 comprises two parts, a first part containing one or more headers due to the network protocol used, and a second part, a payload part, that contains the actual information. The two parts are separated by a dashed line in the figure. The first part contains a field for the MAC header 21 and a field for a command frame header 22. The payload part contains a field 23 for the generated ID, a field 24 for the target network depth TD and a field 25 for the distance counter C.

FIG. 7 shows a second part of the method for relocating address space in a flow chart diagram. In this part of the method, the reaction of a router to the reception of a relocation request is performed.

Accordingly, in a first step S20 a relocation request, e.g. sent in step S17 of FIG. 4, containing an identification number ID, a target network depth TD and a distance counter C is received by a receiving router. The receiving router that performs the part of the method shown in this FIG. 7 is called performing router in connection with the description of FIG. 7. To stick to the example shown in FIG. 1: If the joining request has been received by router 3₁₋₀, the relocation request has been sent to the parent router of router 3₁₋₀, that is to router 3₀₋₀, which accordingly is the performing router for the method steps shown in FIG. 7.

In a next step S21, the performing router checks whether the distance counter C is larger than 0 and whether a parent router is present. If both is true, the method proceeds with a step S22, in which the distance counter C is decremented to a value C′=C−1.

In a next step S23, the relocation request is sent to the parent router of the performing router, containing the identification number ID and the target network depth TD as received, and the decremented distance counter C′. The method thereafter finishes. In other words, what happens is that a relocation request is handed over from router to router upwards the hierarchical tree towards its root node. The initial value of the distance counter C describes how many network levels the request travels upwards, before it is processed any further. Thus, the initial value of the distance counter C determines the reach of the relocation request and also the logical range at which a restructuring of the address space occurs.

If it was determined in step S21 that the distance counter equals 0 or that no parent router is present, e.g. because the root of the tree has already been reached, the method proceeds with a step S24.

The reaction to a relocation request in step S24 and the following steps now mainly depends on the size of the target network depth TD compared to the network depth D of the children of the performing router. Due to the standard procedure of dividing the address space when assigning address blocks from a parent router to child routers as described in step S12 and S13 of FIG. 4 and as shown in FIG. 5, the address space 10 assigned a router directly depends on the network depth D of the router. More precisely, the network depth D of a router and the size of the assigned address space depend on each other in a bijective way.

The target network depth TD as a relocation request parameter is used to determine the size of the requested address space. More precisely, the target network depth TD stands for a request of an address space of the same size, than a router of network depth D=TD has as its address space. By characterizing the requested address space size in terms of the target network depth TD, it is guaranteed that only address space sizes that fit into the standard dividing procedure are requested and assigned. If address space would be requested in other units, for example in bytes, a situation could occur, in which only a part of an address block would be assigned to a joining router in a relocation process, thus leading to the remaining part of the address block being unused and, even worse, possibly unusable if its size being too small. By using the target network depth TD as a characterization of the size of a requested address space, it is ensured that all address blocks are compatible with the ones produced by the standard address space division scheme.

Accordingly, in step S24 the performing router checks whether the requested target network depth TD is equal to the network depth D of its children. In other words, it checks whether the size of the requested address space is equal to the size of its own address blocks. If that is the case, the method proceeds with a step S25.

In step S25, the router checks whether free address blocks are still available. Depending on the result of step S25, parameters for a relocation reply are determined in steps S26 or S27, respectively. In case free address blocks are available, a success flag SF is set to the value 1. Furthermore, parameters describing the free address block, for example the starting address AS and the end address AE, are determined. If a free address blocks is not available, the success flag SF is set to the value 0 and values for the address block parameters AS and AE are either also set to 0 or are not defined at all. In both cases, the method proceeds with a step S28, in which a relocation reply is actually issued. The relocation reply contains the received identification number ID of the relocation request, the value of the success flag SF and, particularly if the success flag is set to 1, the values of the start address AS and the end address AE. The relocation reply can be sent to the router from which the performing router received the relocation request. That way, the relocation reply will travel step by step back to the router that originally released the relocation request, which will be described in more detail in connection with FIG. 9. Another option could be to directly send the relocation reply to the router that originally send the relocation request. This is possible in mesh network systems, in which a communication between routers is not limited to communication along the pathways of the hierarchical address structure tree.

Sticking to the example of FIG. 1, it is assumed that a relocation request had been sent by router 3₁₋₀ with a target network depth TD of 1 and an initial distance counter value C of 0. Having a free address block available (the one allotted for node 2₁₋₁) and having children with a network depth of D=1, i.e. equal to the target network depth TD=1, router 3₀₋₀ as the performing router would now sent a relocation reply with the SF flag set to 1 and according address block parameters AS and AE back to router 3₁₋₀.

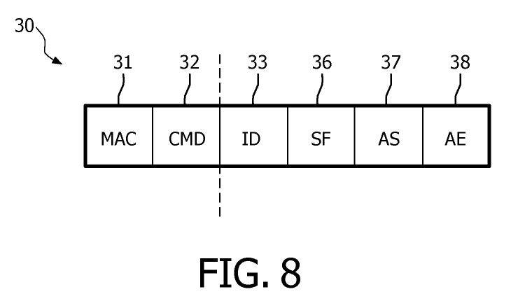

FIG. 8 shows a schematic representation of a relocation reply 30. In analogy to the relocation request 20 shown in FIG. 6, the relocation reply 30 comprises a header part including a MAC header 31 and a command frame header 32, and a payload part, comprising a field 33 for the ID, a field 36 for the success flag SF and fields 37 and 38 for the starting address AS and the end address AE.

Back to FIG. 7, the method continues with a step S29 if in step S24 it was determined that the requested target network depth TD is not equal to the network depth D of the children of the performing router. In step S29, it is determined whether child routers are assigned to the performing router and whether the target network depth TD is larger than the network depth D of the children of the performing router.

If that is the case, the relocation request is forwarded to a first child of the performing router in a step S30. This means that in case the requested address space is smaller (corresponds to a larger value of the target network depth TD) than the address blocks of the performing router are, the request is sent down the tree structure until the size of the requested address space equals the size of the address blocks of a router. This is an additional means to avoid fragmentation of the address space.

If, in step S29, it is determined that either a child router is not present, or that the target network depth TD is not larger than the network depth D of the children of the performing router, the relocation request is returned to the router from which the performing router received it in step S20. In either case, the method finishes after step S30 or S31, the performing router now being ready to receive a further relocation request in step S20 in a repetition of the method, or being ready to receive a reply to the relocation request as described in connection with FIG. 9, or being ready to receive an association request as described in connection with FIG. 4.

FIG. 9 shows a third part of the method for relocating address space in a flow chart diagram. This part of the method describes the reaction of a router to the reception of a relocation reply.

Accordingly, this part starts with the reception of a relocation reply characterized by an identification number ID, a success flag SF, a starting address AS and an end address AE in a first step S40 by a receiving router. The receiving router that performs the part of the method shown in this FIG. 9 is again called performing router in connection with the description of this figure.

In a next step S41, the performing router determines, whether it itself issued the relocation request behind this relocation reply. This can be done on the basis of the contained identification number ID. If the corresponding relocation request was not issued by the router itself, the method continues with a step S42. Otherwise, the method continues with a step S48.

In step S42, the success flag SF is evaluated. If it contains a value of 1, meaning that the relocation request is positively replied, the method continues with a step S43. In this step, the routing table of the performing router is updated. In a following step S44, the relocation reply is forwarded further to the router from which the performing router has received the corresponding relocation request in a former process step S20 of FIG. 4. In other words, the relocation reply travels through the network back to the router that originally released the relocation request. It travels along the same pathway as the relocation request, but in reversed direction. The updating of the routing tables on the way back in step S43 has the advantage that further messages exchanged in the network and directed to the joining router can be sent directly to the joining router without performing any address discovery routine.

If, in step S42, a negative reply (SF equals 0) has been detected, the method continues with a step S45, in which the performing router checks whether more children are present to which the request could be forwarded in analogy to step S30 of FIG. 7. In case more children are present, the method branches to step S46, in which the relocation request, which had been received in step S20 of FIG. 7 is forwarded to the next child with unchanged parameters for the identification number ID, the target network depth TD and the distance counter C, which in this case equals zero. Steps S45 and S46 thus complete the possibility of a relocation request traveling down the tree in order to additionally avoid fragmentation of the address space as described in connection with step S30 of FIG. 7.

If no more children are present, the method continues with a step S47, in which the relocation reply as received in step S40 is forwarded with unchanged parameters as a negative reply to the router from which the relocation request has been received. Thus, similar to steps S43 and S44, the steps S45 and S47 have the purpose of forwarding the relocation reply back to the originator of the relocation request.

If, in step S41, it was discovered that the received relocation reply belongs to a relocation request that the current router has issued itself, a method now continues with step 48. In step 48, the success flag SF of the relocation reply is evaluated. In case of a positive relocation reply with a success flag SF equals 1, the method continues with a step S49, in which the routing table of the current router is updated in analogy to step S43. Then finally, in a following step S50, an association reply containing the address block parameters starting address AS and end address AE is sent to the joining router that had issued the association request received in S10 of FIG. 4.

The sequence of steps S40, S41 S48, S49 and S50 would be performed in case of the example of FIG. 1, when router 3₁₋₀ would receive the positive relocation reply issued by router 3₁₋₀ in step S28 of FIG. 7.

If, in step S48, a negative relocation reply (SF equals 0) has been detected, the method continues with a step S51. In step S51, a new identification number ID* is generated for a new relocation request. In a next step S52, new relocation parameters, a new target network depth TD* and a new distance counter C* are additionally determined.

The values of the relocation parameters of course have a big influence on the success of a relocation request. For example, in order to save time and computing power, a relocation request can first be issued with a small value for the distance counter. As a result, the relocation request only travels within close proximity of the requesting router. Thus, free address blocks with appropriate size as characterized by the target network depth TD may not be found, even if they are present in the network, since they might not lie within the travel range of the relocation request and belong to routers which have not been checked for free address blocks. In a similar manner, a first relocation request could have been issued with small values for the target network depth TD, which is equivalent to relatively large requested address space sizes. Even in case such a request has been replied with a negative reply, a new request with a larger value for the target network depth TD, thus aiming for a smaller sized addressed space only, might lead to a positive reply.

Different strategies for determining the relocation request parameters might here be implemented, which make a trade-off between the following competing goals. One goal could be to minimize the number of relocations required to connect all devices to a network, another goal could be to minimize the overall number of routing table entries and another goal might for example be to minimize the number of transmitted relocation requests and relocation replies required for one relocation process.

Depending on the weight of the desired goals, a first strategy might be to first try to allocate large address spaces, that is use a target network depth TD=1 and successively increase the target network depth until successful. This way, the maximum depth of the network will increase rapidly and especially networks with long chain of routers will require only a few relocation processes.

A second strategy might be to relocate the smallest address blocks still available by first searching for blocks with the maximum depth currently present in the network and then successively decrease the target depth. This strategy favors networks with few routers that have many router children.

A trade-off between the two fore mentioned strategies is given by a third strategy that tries to maintain the tree structure predefined by the standard procedure for dividing address space as described in connection with steps S12 and S13 of FIG. 4. In case of the third strategy, a router might first request address blocks of the same size as the address blocks given to its own children that are already connected. The tree structure is thereby maintained.

In all cases and for all strategies, the search should first be conducted in the proximity of the requesting router, that is with a small initial value, for example 0 or 1, for the distance counter C. In further searches, the initial value for the distance counter C should only be increased gradually if required.

After the determination of new relocation parameters in step S52 according to one of the mentioned or further relocation strategies, a new relocation request with the new ID* and new relocation parameters TD* and C* is sent to the parent router of the performing router in a step S53.

In an alternative embodiment, a so called pruning table can be introduced to the network. The pruning table speeds up the search process to find unused address blocks, in particular if these address blocks are located at network levels with a higher network depth.

As already mentioned, the steps S29 and S30 of FIG. 7 in combination with steps S45 and S46 of FIG. 9 lead to a recursive search for unused address blocks that departs from the direct travel path of the relocation request towards the root node, and thus make a downward search possible.

The pruning table contains values of the network depths of the lowest depth child that is a descendant of a particular router. The pruning table is continuously updated to contain this value characterizing the largest address block size that can be relocated by the router child itself and also by its descendants. By default, the value for a newly joint child router in the pruning table is set to the network depth of the child router plus one. If any further relocation of a larger address block underneath this child takes place, the pruning value is updated. In further relocation requests, routers need to forward relocation requests in step S30 of FIG. 7 and step S46 of FIG. 9 only to those child routers with an associated pruning value being equal or smaller than the target network depth TD of the relocation request. When processing a relocation reply, values of the pruning table can be updated if in a positive relocation reply, a previously available address block becomes assigned or will be assigned.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for relocation address space in a peer-to-peer network with hierarchical addressing, wherein the network has a tree structure with routers at different network depths (D) as nodes, each router having an assigned address space, including an identifying address for the router, one or more address blocks for providing child routers with assigned address space and a further address block for providing end devices with identifying addresses, wherein the size of the address space assigned to a router without relocation depends on the network depth (D) of the router in a predetermined way, leading to specific sizes of the address spaces assigned to routers, the method comprising the steps of:
receiving a joining request from a joining router or a joining end device by a first router, the address space of which being exhausted;
sending a relocation request to a second router of the network, wherein the relocation request denotes a size of a requested address block, and wherein the size of the requested address block equals one of the specific address space sizes.

2. The method according to claim 1, wherein the size of the address space assigned to a router without relocation depends on the network depth (D) of the router in a bijective way, and wherein the relocation request denotes the size of a requested address block in terms of a target network depth (TD).

3. The method according to claim 1, wherein the second router is the parent of the first router.

4. The method according to claim 1, wherein the relocation request includes a distance counter value (C), and wherein the second router performs the following further steps after having received the relocation request:
determining whether the distance counter value (C) equals zero;
forwarding the relocation request to a third router, the third router being the parent of the second router, with a distance counter value (C) decreased by one, if it was determined that the distance counter value (C) was not equal to zero; and
processing the relocation request further, if it was determined that the distance counter value (C) was equal to zero.

5. The method according to claim 4, wherein processing the relocation request further comprises the further steps of:
determining, whether the target network depth (TD) is equal to the network depth of possible child routers of the second router; and
if it is, performing an availability check to determine, whether at least one free address block of the requested size according to the value of the target network depth (TD) is available, and issuing a relocation reply that contains the result of the availability check and, in case the at least one free address block is available, parameters describing the respective free address block, and
otherwise processing the relocation request further.

6. The method according to claim 5, wherein, the parameters describing a free address block comprise a starting address (AS) and an end address (AE).

7. The method according to claim 5, wherein, if it was determined that the target network depth (TD) is not equal to the network depth of possible child routers of the second router, processing the relocation request further comprises the further steps of:
determining, whether child routers of the second router exist and whether the target network depth (TD) is larger than the network depth (D) of the child routers of the second router; and
if that is the case, forwarding the relocation request to a child router of the second router; and
otherwise, return the relocation request.

8. The method according to claim 7, wherein the relocation request is forwarded successively to each child router of the second router, until a relocation reply with a positive result of the availability check is issued.

9. The method according to claim 7, comprising the following further steps after a router received the relocation reply:
determining, whether the router is the first router that issued the relocation request to which the relocation reply refers; and
if that is the case, sent a positive answer to the joining router that comprises the address block parameters, if the relocation reply indicated a positive result of the availability check, and issue a new relocation request, if the relocation reply indicated a negative result of the availability check;
otherwise, forward the relocation reply towards the first router if it indicates a positive result of the availability check, and return the relocation reply if it indicates a negative result of the availability check.

10. The method according to claim 9, wherein a new relocation request differs from a further relocation request by different values for the target network depth (TD) and/or the distance counter (C).

11. The method according to claim 9, wherein the values for the target network depth (TD) and/or the distance counter (C) of a relocation request are determined according to a predetermined relocation strategy.

12. The method according to claim 9, wherein a pruning table is maintained that comprises, for each router, values of the network depths of the lowest depth child router that is a descendant of the particular router.

13. The method according to claim 9, performed recursively by all routers of the network.

14. The method according to claim 9, performed in a network according to the ZigBee-specification.

15. A router for use in a peer-to-peer network with hierarchical addressing, the router being suited to perform a method for relocation address space according to claim 9.
